(19) United States
(12) Patent Application Publication
(10) Pub. No.: US 2021/0100218 A1
(43) Pub. Date: Apr. 8, 2021

(54) PET COMPONENT ATTACHMENT SYSTEM

(71) Applicant: TRUE DOGS, LLC, Boulder, CO (US)

(72) Inventor: Adam Baker, Boulder, CO (US)

(21) Appl. No.: 16/595,153

(22) Filed: Oct. 7, 2019

(51) Int. Cl. A01K 15/02; F16B 2/14

(52) U.S. Cl. CPC A01K 15/025; F16B 2/14

(57) ABSTRACT

An attachment mechanism is configured to maintain connection between a first pet component and a second pet component. The attachment mechanism includes an elongated body, a first stop, and a second stop. The elongated body includes a stem having a stem width. The first stop is disposed adjacent an end of the elongated body and has a first width. The second stop is disposed on the elongated body and is spaced from the first stop. The second stop has a second width. The first width and the second width are larger than the stem width. Each of the first stop and the second stop is configured to limit removal of the second pet component from the first pet component.

### BACKGROUND

The present invention relates to attachments to dog toys, and more particularly to dog toys with an attachment mechanism that couples a first dog toy to a second dog toy.

### SUMMARY

In one aspect, the invention provides An attachment mechanism is configured to maintain connection between a first pet component and a second pet component. The attachment mechanism includes an elongated body, a first stop, and a second stop. The elongated body includes a stem having a stem width. The first stop is disposed adjacent an end of the elongated body and has a first width. The second stop is disposed on the elongated body and is spaced from the first stop. The second stop has a second width. The first width and the second width are larger than the stem width. Each of the first stop and the second stop is configured to limit removal of the second pet component from the first pet component.

According to another embodiment of the invention, a pet component system includes a first pet component, a second pet component, and an attachment mechanism. The first pet component has a hole. The second pet component has a hole. The attachment mechanism includes a body and a second end. The body has a first end that is insertable into and secured to the first pet component. The second end is insertable into and secured to the second pet component.

According to a further embodiment of the invention, an attachment mechanism configured to maintain connection between a first pet component and a second pet component. The attachment mechanism includes a first attachment point, a second attachment point, and a third attachment point. The first attachment point is disposed on a first end of a stem. The second attachment point is disposed on a second end of the stem. The third attachment point is disposed on the stem between the first end and the second end of the stem. The first attachment point has a cross sectional area that is larger than cross sectional areas of the second attachment point and the third attachment point.

### BRIEF DESCRIPTION OF THE DRAWINGS

FIG. 1 is a perspective view of a pet component attachment system according to an embodiment of the invention.

FIG. 2 is a side view of an attachment mechanism of the pet component attachment system of FIG. 1.

FIG. 3 is a view of the pet component attachment system with a portion of the first pet component removed and illustrating the second pet component and the attachment mechanism in an uncoupled position relative to the first pet component.

FIG. 4 is a front view of the pet component attachment system with a portion of the first pet component removed and illustrating the second pet component and the attachment mechanism in an first coupled position relative to the first pet component.

FIG. 5 is a front view of the pet component attachment system with a portion of the first pet component removed and illustrating the second pet component and the attachment mechanism in an second coupled position relative to the first pet component.

### DETAILED DESCRIPTION

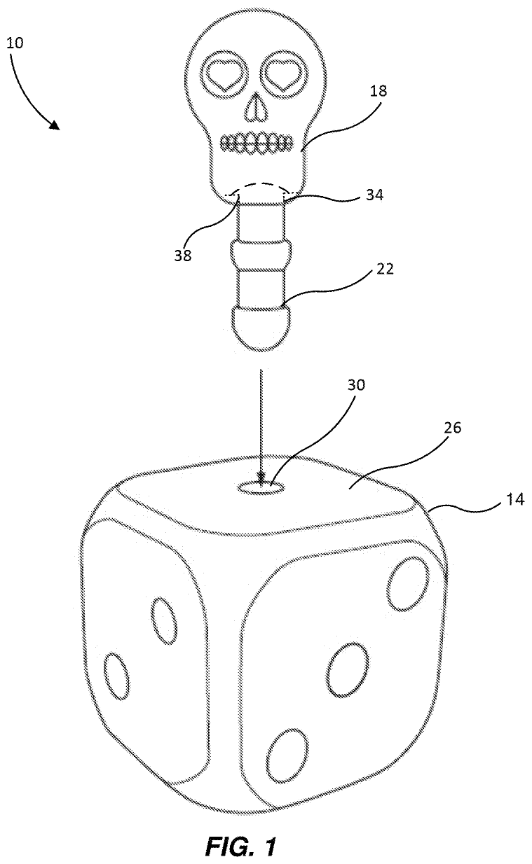

FIG. 1 illustrates a pet component attachment system 10 that includes a first pet component 14 (e.g., a toy) and a second pet component 18 that is coupled to the first pet component 14 via an attachment mechanism 22. In the illustrated example, the first pet component 14 is hollow and cuboid-shaped, and includes a first wall 26 with a hole 30 that extends through the first wall 26. While the illustrated hole 30 is cylindrical (i.e. circular in cross-section), it will be appreciated that the hole 30 can have other shapes in cross-section (e.g., polygonal, elliptical, etc.). The first pet component 14 can take any form or shape (e.g., a cone, a sphere, a dodecahedron, etc.), and the first pet component 14 can be formed of any material that is suitable for a pet to play with or bite (e.g., a malleable material such as rubber, nylon, etc., or a plastic material).

In the illustrated example, the second pet component 18 is hollow and irregularly shaped—in the form of a three dimensional head—and includes a second wall 34 with a hole 38 that extends through the second wall 34. While in the preferred embodiment the hole 38 is cylindrical (i.e. circular in cross-section), it will be appreciated that the hole 38 can have other shapes in cross-section (e.g., polygonal, elliptical, etc.). The second pet component 18 can take any form or shape, and the second pet component 18 can be formed of any material that is suitable for a pet to play with or bite (e.g., a malleable material such as rubber, nylon, etc., or an edible material in the form of a pet treat). Other materials are also considered herein.

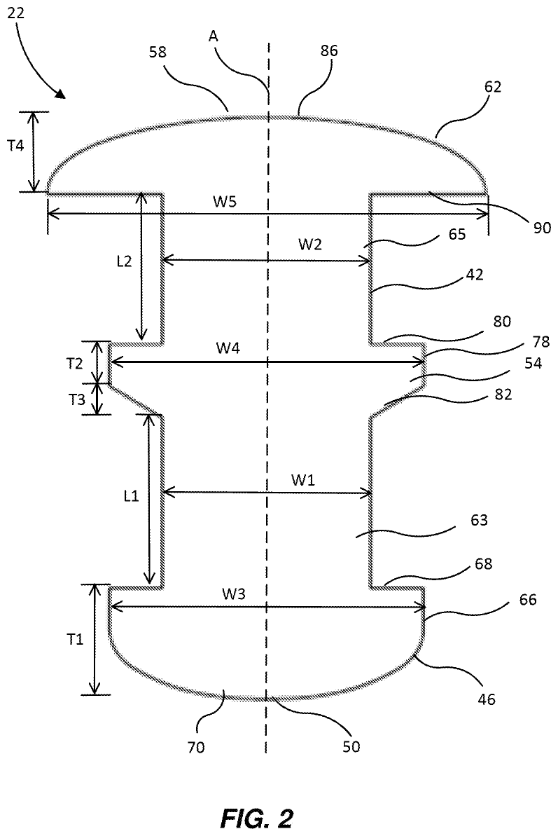

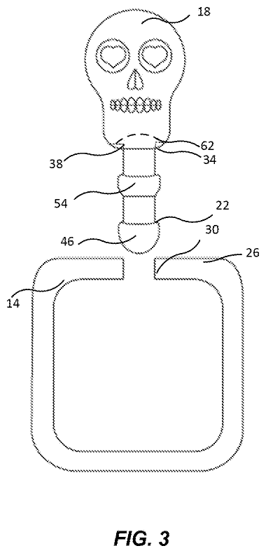

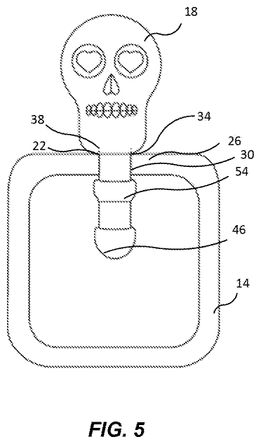

With reference to FIGS. 3-5, the attachment mechanism 22 removably couples the second pet component 18 to the first pet component 14 such that the first pet component 14 and the second pet component 18 may be used individually or together. With reference to FIG. 2, the attachment mechanism 22 is defined by an elongated body or stem 42 that has a first stop or attachment point 46 disposed at a first end 50 of the elongated body 42, a second stop or attachment point 54 located on the elongated body 42 and spaced from the first stop 46 and a second end 58 of the elongated body 42 (e.g., adjacent a middle of the elongated body 42), and a third stop or attachment point 62 disposed at the second end 58 of the elongated body 42. The elongated body 42 also has a first stem portion 63 that interconnects the first stop 46 and the second stop 54, and a second stem portion 65 that interconnects the second stop 54 and the third stop 62. The illustrated stops 46, 54, 62 and the first and second stem portions are generally circular in cross-section (taken horizontally in FIG. 2; as shown, the stems 63, 65 are cylindrical). It should be appreciated that the shapes for each of the stops 46, 54, 62 can be the same or different from each other, and that the first and second stem portions 63, 65 can have an elliptical cross-section or a polygonal cross-section. In general, and as explained in more detail below, it is preferred that the cross-section of the stems substantially conform to, or match, the shape of the holes 30, 38.

With continued reference to FIG. 2, the first stem portion 63 has a first width W1 (e.g., a diameter when the cross-section is circular) and extends axially a first length L1 between the first stop 46 and the second stop 54. The second stem portion 65 has a second width W2, and extends axially a second length L2 between the second stop 54 and the third stop 62. As shown, the second width W2 is equal to the first width W1, although the widths W1, W2 may be different in some constructions (e.g., based on the respective sizes of the holes 30, 38). For example, the first and second widths W1, W2 may be between 6 mm and 18 mm. In the illustrated construction, the first width W1 is approximately 12 mm. In some constructions, the first and second widths may be less than approximately 6 mm or more than 18 mm. As shown, the lengths L1, L2 of the stem portions 63, 65 are equal (e.g., approximately 10 mm), although the lengths L1, L2 may be different (e.g., based on the thickness of the wall defining the first pet component 14 or the second pet component 18).

The illustrated first stop 46 is defined by a cylindrical portion 66 with a shoulder 68 and a curved portion 70. The curved portion 70 defines the first end 50 of the elongated body 42 and facilitates insertion of the attachment mechanism 22 into the hole 30. The first stop 46 has a third width W3 (e.g., a diameter when the cross-section is circular) defined by the cylindrical portion 66 that is larger than the first width W1. In the illustrated construction, the third width W3 is approximately 16 mm. In some constructions, the third width W3 can be between approximately 10 mm and 22 mm. The first stop 46 also has a first thickness T1 (defined along an axis A of the elongated body 42) to provide adequate rigidity to the first stop 46 while permitting modest deformation of the first stop 46 so that the first stop 46 can pass through the hole 30. In the illustrated construction, the first thickness T1 of the first stop 46 is approximately 12.5 mm, although other thicknesses are considered herein (e.g., between approximately 6 mm and 18 mm).

The illustrated second stop 54 is defined by an annular ring or protrusion that is generally wedge-shaped in vertical cross-section (as viewed in FIG. 2). More specifically, the second stop 54 shown in FIG. 2 includes a radial surface 78, a stop surface or shoulder 80, and a wedge surface 82. The radial surface 78 defines a fourth width W4 of the second stop 54 (e.g., a diameter when the cross-section is circular) that is larger than the first width W1 and the second width W2. In the illustrated construction, the fourth width W4 is approximately 16 mm. In some constructions, the fourth width W4 can be between approximately 10 mm and 22 mm. Due to the wedge-shape of the second stop 54, the second stop 54 has a second thickness T2 (along the axis A) in line with the axial extent of the stem portions 63, 65, and a third thickness T3 (along the axis A) at the radial extent of the second stop 54. In the illustrated construction, the second thickness T2 is approximately 7.5 mm and the third thickness T3 is approximately 5 mm. It will be appreciated that the width W5 and the thicknesses may have other dimensions. The shape and thicknesses of the second stop 54 cooperate such that the second stop 54 has adequate rigidity to generally inhibit removal of the second stop from the first pet component 14 while permitting modest deformation of the second stop 54 into the first pet component 14 through the hole 30.

As shown in FIG. 2, the third stop 62 is defined by a curved cap 86 that has a shoulder 90 (e.g., forming a generally mushroom-shaped body when considered with the second stem 65). The curved cap 86 defines the second end 58 of the elongated body 42 and facilitates insertion of the attachment mechanism 22 into the hole 38. The shoulder 90 is defined by a planar surface, although the shoulder 90 can be defined by a non-planar surface. The third stop 62 has a fifth width W5 (e.g., a diameter when the cross-section is circular) that is larger than the second width W2. In the illustrated construction, the fifth width W5 is approximately 30 mm. In some constructions, the fifth width W5 can be between approximately 10 mm and 50 mm. While the fifth width W5 can be the same as the third width W3, it is preferred that the fifth width W5 be larger than the third width W3 so that the attachment mechanism 22 would detach from the first pet component 14 before the second pet component 18 detaches from the attachment mechanism 22. The third stop 62 also has a fourth thickness T4 (defined along an axis A of the elongated body 42) to provide adequate rigidity to the third stop 62 while permitting modest deformation of the third stop 62 so that the third stop 62 can pass through the hole 38. In the illustrated construction, the fourth thickness T4 approximately 10 mm, although other thicknesses are considered herein (e.g., between approximately 6 mm and 18 mm). The fourth thickness T4 may be less than, equal to, or greater than the thickness of the first stop 46.

The illustrated elongated body 42 is a monolithic component that can be formed via a molding process or another suitable process. For example, the elongated body 42 may be formed of the same material as the first component 14 or the second pet component 18 (or both components 14, 18), or a different material. For example, when the second pet component 18 is formed from an edible material, the attachment mechanism 22 may also formed from the edible material.

With reference to FIGS. 3-5, the second pet component 18 is attached to the attachment mechanism 22 by inserting the third stop 62 through the hole 38 (e.g., via a snap-fit connection). The curvature of the curved cap 86 facilitates insertion of the third stop 62 into the second pet component 18 through the second wall 34 by permitting sufficient deformation of the third stop 62 and/or the hole 38. After insertion, the shoulder 90 is engaged with an interior of the second wall 34 to retain the second stop 54 in the second pet component 18 and resist removal. In some constructions, the second pet component 18 and the attachment mechanism 22 may be formed integrally (e.g., as a monolithic element, when both are formed of the same material, or co-molded when formed of different materials).

Generally, the second pet component 18 is coupled to the attachment mechanism 26 before the attachment mechanism 22 is attached to the first pet component 14, although the order of assembly can be different. As illustrated, the attachment mechanism 22 is attached to the first pet component 14 by pressing the first stop 46 through the hole 30. The first stop 46 slightly deforms to pass through the hole 30. In some constructions, the hole 30 and the first stop 46 each may deform (e.g., based on the material of the first pet component 18 and the first stop 46). The curvature of the curved portion 70 facilitates insertion of the first stop 46 into the first pet component 14 through the first wall 26 by permitting sufficient deformation of the first stop 46 and/or the hole 30. After insertion, the shoulder 68 is engaged with an inner surface of the second wall 34 to retain the first stop 46 in the first pet component 14 and resist removal. In this arrangement or orientation, the second pet component 18 is spaced a first distance from the first pet component 14.

The attachment mechanism 22 is designed to inhibit detachment of the second pet component 18 from the attachment mechanism 22 (in constructions where the two components are not formed integrally or monolithically), as well as inhibit detachment relative to the first pet component 14. The first stop 46 generally resists removal of the attachment mechanism 22 from the first pet component 14, and the second stop 54 bolsters the connection to the first pet component 14. More specifically, the second stop 54 is inserted into the first pet component 14 by pressing the second stop 54 through the hole 30. The wedge-shape of the second stop 54 facilitates slight deformation of the second stop 54 (and in some cases, deformation the first pet component 14, depending on the materials used) and relative ease of insertion so that the second stop 54 snaps into place and the shoulder 80 is engageable with the interior side of the first wall 26. The shoulder 80 provides a second or additional mechanism that inhibits disengagement between the attachment mechanism 22 and the first pet component 14. When the second stop 54 is engaged with the interior side of the wall 26, the first stop 46 is disposed within the interior of the first pet component 14 (i.e. spaced interiorly from the wall 26). In this arrangement or orientation, the second pet component 18 is spaced a second distance from the first pet component 14, and the second distance is larger than the first distance.

After assembly, and in use, the first pet component 14 and the second pet component 18 are attached to each other via the attachment mechanism 22 in a way that resists or prevents removal of the attachment mechanism 22 from the first pet component 14. For example, a dog may play with, chew on, or tug at the assembled first and second pet components 14, 18. The engagement between the second stop 54 and the first wall 26 (via the shoulder 80) resists or inhibits withdrawal of the second stop 54 from the first pet component 14.

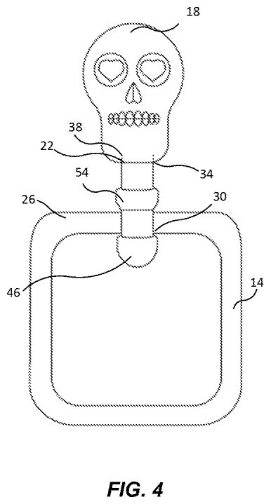

If the second stop 54 is dislodged from the first pet component 14, the first stop 46 acts to resist or inhibit withdrawal of the attachment mechanism 22 from the first pet component 14. For example, when the pet component attachment system 10 is in the orientation or position illustrated in FIG. 4 (i.e. after the second stop 54 is dislodged from the first pet component 14), the dog must apply another, independent force to the second pet component 18 (through the attachment mechanism 22) to dislodge the first stop 46 from the first pet component 14. Due to the sequential stops 46, 54, it is very difficult for a dog (or another animal) to completely remove or dislodge the attachment mechanism 22 from the first pet component 14 (generally at least not before the second pet component 18 has been eaten or otherwise chewed up).

It will be appreciated that the shapes of the stops 46, 54, 62 and the corresponding holes 30, 38 may be different than illustrated. The illustrations serve only as examples of how an attachment mechanism with two stops that are engageable with the same pate component to attach that pet component to another pet component (e.g., any combination of pet toys or edibles) and inhibit removal of one pet component from the other.

Although the invention has been described in detail with reference to certain preferred embodiments, variations and modifications exist within the scope and spirit of one or more independent aspects of the invention as described.

1. An attachment mechanism configured to maintain connection between a first pet component and a second pet component, the attachment mechanism comprising:
an elongated body including a stem portion having a stem width measured perpendicular to an axis extending longitudinally through the elongated body;
a first stop disposed adjacent an end of the elongated body and having a first width measured perpendicular to the axis; and
a second stop disposed on the elongated body and spaced from the first stop, the second stop having a second width measured perpendicular to the axis,
wherein the first width and the second width are larger than the stem width, and wherein each of the first stop and the second stop is configured to separately limit removal of the second pet component from the first pet component.

2. The attachment mechanism of claim 1, wherein the first stop has a first shoulder engageable with an interior of the first pet component, and the second stop has a second shoulder engageable with an interior of the first pet component.

3. The attachment mechanism of claim 1, wherein the first stop has a first thickness and the second stop has a second thickness that is smaller than the first thickness.

4. The attachment mechanism of claim 1, wherein the first stop at least partially cylindrically-shaped, and wherein the second stop is at least partially cylindrically-shaped.

5. The attachment mechanism of claim 1, wherein the first stop has a width that is approximately equal to a width of the second stop.

6. The attachment mechanism of claim 1, wherein the end is a first end, and the attachment mechanism further comprises a third stop disposed at a second end of the elongated body that is opposite the first end.

7. The attachment mechanism of claim 6, wherein the third stop has a width that is larger than a width of the second stop.

8. The attachment mechanism of claim 6, wherein the first stop has a curved portion and the third stop has a curved cap.

9. The attachment mechanism of claim 1, wherein the second stop is defined by an annular wedge-shape, and wherein the second stop has a shoulder defining a radial surface engageable with the interior of the first pet component and a wedge surface opposite the radial surface.

10. A pet component attachment system including:
a first pet component having a first hole; and
a second pet component with a second hole; and
an attachment mechanism including a body with a first end configured to be inserted into and secured to the first pet component via the first hole, and a second end configured to be inserted into and secured to the second pet component via the second hole.

11. The pet component attachment system of claim 10, wherein the first end includes a first stop having a first shoulder engageable with an interior wall of the first pet component, the attachment mechanism further comprising a second stop spaced from the first stop along the body, the second stop having a second shoulder engageable with the interior wall of the first pet component.

12. The pet component attachment system of claim 11, wherein the second end of the attachment mechanism includes a third stop having a third shoulder engageable with an interior wall of the second pet component.

13. The pet component attachment system of claim 12, wherein the first stop has a first thickness and the second stop has a second thickness that is smaller than the first thickness.

14. The pet component attachment system of claim 12, wherein the second pet component is spaced a first distance from the first pet component when the first stop is engaged with the interior wall of the first pet component, and wherein the second pet component is spaced a second distance from the first pet component when the second stop is engaged with the interior wall of the first pet component, the second distance being smaller than the first distance.

15. An attachment mechanism configured to maintain connection between a first pet component and a second pet component, the attachment mechanism comprising:
a stem having a first end and a second end;
a first attachment point configured to engage the first pet component, the first attachment point disposed on the first end and having a first width;
a second attachment point configured to engage the first pet component, the second attachment point disposed on the second end and having a second width; and
a third attachment point configured to engage the second pet component, the third attachment point disposed on the stem between the first end and the second end, the third attachment point having a third width that is larger than the first width.

16. The attachment mechanism of claim 15, wherein the third width is larger than the second width.

18. The attachment mechanism of claim 17, wherein the first attachment point and the second attachment point separately secure the second pet component to the first pet component.

19. The attachment mechanism of claim 15, wherein the first attachment point has a first thickness and the second attachment point has a second thickness that is smaller than the first thickness.

20. The attachment mechanism of claim 19, wherein the stem has a stem width that is smaller than the first width, the second width, and the third width.
